(19) United States
(12) Patent Application Publication
(10) Pub. No.: US 2005/0193935 A1
(43) Pub. Date: Sep. 8, 2005

(54) Irrigation water, herbicide, pesticide, and fertilizer conservation system for farming

(76) Inventor: Steven A. Schneider, San Rafael, CA (US)

Correspondence Address: RICHARD BREWSTER MAIN;PATENT ATTORNEY, P.O. BOX 1859, LOS ALTOS, CA, 94022, US

(21) Appl. No.: 11/112,382

(22) Filed: Apr. 25, 2005

Related U.S. Application Data
(63) Continuation-in-part of application No. 10/771,244, filed on Feb. 2, 2004.

(51) Int. Cl. A01C 1/00

(52) U.S. Cl. 111/200

(57) ABSTRACT

A farming system compensates for soils that drain too well by underlaying the crop fields with a planar network of liquid reserve matrices. These are placed at the bottom of the root zone, below the level that ordinary seasonal tilling will reach. In one version, the top soil is laid open and the underlayment is patterned out like carpet tiles. The top soil is then back filled to bury the liquid reserve matrices at a predetermined depth. In another version, individual cone shaped cups are forcibly driven deep into the ground below the seasonal tilling depth. Both versions can then enable reductions in the necessary volumes of watering, fertilizing, and application of herbicides and pesticides because the individual buried wells will catch some of the drainage and keep it near the root zone.

### RELATED APPLICATIONS

This is a continuation-in-part to U.S. patent application Ser. No. 10/771,244, filed Feb. 2, 2004, and titled, BURIED WATER RESRVOIRING NETWORK FOR PLANT CULTIVATION, by the present inventor, Steven A. SCHNEIDER.

### BACKGROUND

1. Field of the Invention

The present invention relates to plant farming, and more particularly to methods and devices for conserving irrigation water, pesticide, herbicides, and fertilizers used to grow crops.

2. Description of the Prior Art

Most cash crops grow on the surface of the ground and their roots extend into the soil. For vegetables like potatoes, the valuable part is underground and involved with the roots. For fruits like apples, the valuable fruit grows high up in the tree well above the ground.

Plant species have adapted to just about every soil, weather, watering, pest, and nutrient condition that exists on earth. So the optimum conditions that will promote healthy growth vary dramatically, and are species specific.

Stressing any plant with extremes of temperature, soil, water, nutrients, etc. can stunt its growth. Cycling between extremes, like in night-and-day, winter-and-summer, wet-and-dry, can exhaust a plant or trigger it into and out of dormancy. Crop periods can be shortened. Some plants open up to absorb water when they sense water is available, and close back up again to reduce water losses and evaporation. Soil conditions that drain too well can starve a plant for water, and soils that retain water too well can promote mildew, fungus and rot.

Farming has become big business. Single species crops can occupy thousands of acres. Many crops are routinely irrigated, fertilized, and dosed with pesticides. Very often these can leach through the soil quickly and wind up in the ground aquifer, rivers, lakes, seas, and oceans. If they don't stay resident very long with the root system of the crop, they can't do their respective jobs. Over thousands of acres, the soil, drainage, and other conditions can vary around an average. The average should be the optimum conditions, and these variations can adversely affect crop yields and production.

For interest, the reader is referred to German Patent DE 35 02 296 A1, by Hans Steinbronn, issued Jul. 24, 1986, which describes burying many contiguous concave reservoir basins beneath plants. Title, “Unterlage fuer ein zur Dachbegruenung dienendes Pflanzsubstrat (Document for a planting substrate serving for the roof planting)”. Load-bearing slab for a plant substrate for providing greenery on roofs.

### SUMMARY OF THE INVENTION

Briefly, a farming system embodiment of the present invention compensates for soils that drain too well by underlaying the crop fields with a planar network of liquid reserve matrices. These are placed just below the root zone, and below the level that ordinary seasonal tilling will reach. In one embodiment, the top soil is laid open and the underlayment is patterned out like carpet tiles. The top soil is then back filled to bury the liquid reserve matrices at a predetermined depth. In another embodiment, individual cone shaped cups are forcibly driven deep into the ground below the seasonal tilling depth. The method then reduces the volumes of watering, fertilizing, and application of herbicides and pesticides because the individual buried wells will catch some of the drainage and keep it near the root zone.

An advantage of the present invention is that a farming system and method are provided for plant cultivation that reduces the dry-wet cycling and concomitant stress on crops.

Another advantage of the present invention is a farming method is provided that produces greater crop yields with less water, fertilizers, and pesticides.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a cross-sectional view of a planted farm crop in a farming system embodiment of the present invention;

FIG. 2 is a graph comparing the wet-dry cycles and stresses that traditional farming methods and method embodiments of the present invention place on commercial crops;

FIG. 3A is a cross-sectional view of a field to be planted with farm crop in a farming system embodiment of the present invention;

FIG. 3B is a cross-sectional view showing a machine that forcibly buries conical reserve wells in a field to be planted with farm crop in an embodiment of the present invention; and

FIG. 3C is a cross-sectional view of a farm crop in a system embodiment of the present invention after the machine in FIG. 3B has finished and the plants are in cultivation;

FIG. 4 is a perspective diagram of a set of tapered reservoir cups in an embodiment of the present invention; and

FIG. 5 is a perspective diagram of a thermoformed sheet of tapered reservoir cups in an embodiment of the present invention.

### DETAILED DESCRIPTION OF THE PREFERRED EMBODIMENT

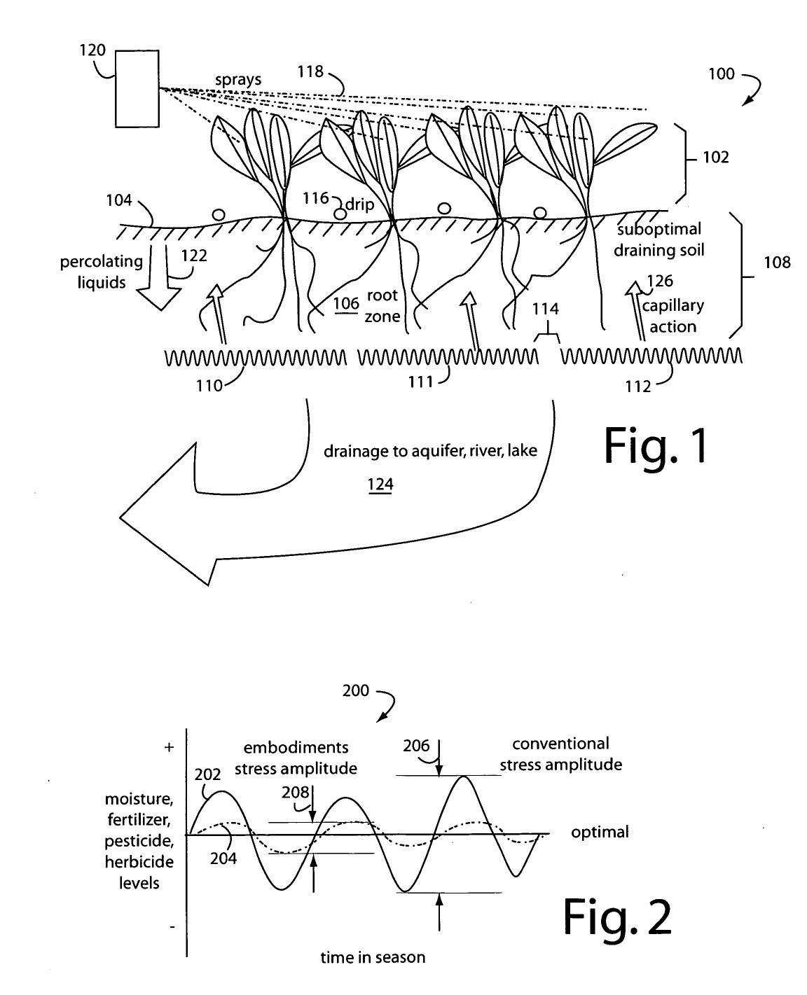

FIG. 1 a farming system embodiment of the present invention, and is referred to herein by the general reference numeral 100. The farming system 100 includes a commercial crop of plants 102 that are being cultivated by a business in a field 104. The roots of the plants 102 extend into a root zone 106. Here the plants 102 can absorb moisture, fertilizers, herbicides, and pesticides. An overburden 108 of sub-optimally draining soil is back-filled over a planar network of liquid reserve matrices 110-112. The individual matrices 111 and 112 have a gap 114 separating them. A drip irrigation system 116 provides water to irrigate the plants. A spray of fertilizers, pesticides, herbicides, and/or water is periodically applied by a spray system 120. This all results in a flow of percolating liquids 122 that will pass through the overburden 108.

Such overburden 108 comprises “suboptimal draining soil”. It can either be the natural top soil occurring in the area, or soil that was brought in to do the farming. The not perfect soil allows the liquids to drain away faster than the plants can take them in. Therefore, the volumes and frequency of application need to be higher than if the soil was better in regard to drainage. Over an entire farm, such soils will vary and the required applications in each area will also vary.

Given the practical frequencies and volumes of fertilizers, pesticides, herbicides, and/or water that can be applied in a commercial farming business, the soil conditions can become too dry. In order to compensate for this, conventional system apply too much so the average conditions will be optimal over time. But these swings between too much and too little will stress the plants 102 and attenuate their growth during the season.

Excess percolating liquids 122 will appear in a deep groundwater drainage 124 that can pollute the water table, rivers, lakes, and the oceans. Each of these liquids came at a cost, both for the material and their delivery. So the liquids that enter drainage 124 are wasted.

Embodiments of the present invention trap some of these percolating liquids 122 in the buried network of liquid reserve matrices 110-112. Small wells in the top surfaces of each will collect the liquids and keep them resident in the root zone 106. A capillary action 126 can cause the liquids to move higher in the soil.

In one embodiment of the present invention, the buried network of liquid reserve matrices 110-112 was implemented with ordinary egg flats made of molded wood pulp. These were then sprayed with a waterproofing so they would continue to operate for at least one season. The choice of egg flats had the advantages of being very inexpensive, already in mass production everywhere in the world, highly familiar to ranchers and farmers, and biodegradable. A typical egg flat has thirty wells that each will hold a volume of twenty-six milliliters before spilling. Each flat is about 11″ by 12″ with a 2″ deep corrugation. These have been experimentally tested and buried at a depth of twelve inches and packed edge-to-edge, e.g., zero gap 114. The species of crop being cultivated, the soil conditions, and the costs of irrigation will empirically dictate the optimal depth and spacings necessary.

Other embodiments of the present invention can implement the network of liquid reserve matrices 110-112 with various kinds and shapes of cups or basins made from plastics and other materials.

FIG. 2 represents a graph 200 comparing plant stresses by conventional farming and the reduces stresses that occur with embodiments of the present invention. There is an optimal amount of liquids that can be resident in the soil, this is represented by the x-axis baseline. A conventional method curve 202 represents the extreme cycling that occurs with traditional methods of watering, fertilizing, and applying other chemicals. Drip irrigation has been a way to reduce the amplitudes of such cycling, but soil drainage that is too rapid must be compensated for by over-watering, over-fertilizing, and over-application of pesticides and herbicides. A curve 204 represents a method embodiment of the present invention where the amount of over-watering, over-fertilizing, and over-application of pesticides and herbicides has been reduced because the over-drainage has been controlled using liquid reserve matrices 110-112 (FIG. 1). The peak-to-peak amplitude 206 is much greater than peak-to-peak amplitude 208. Over a growing season, plant crops that were stressed less (curve 204) have been observed in experiments to be substantially larger and better developed than control plant crops subject to stress curve 202.

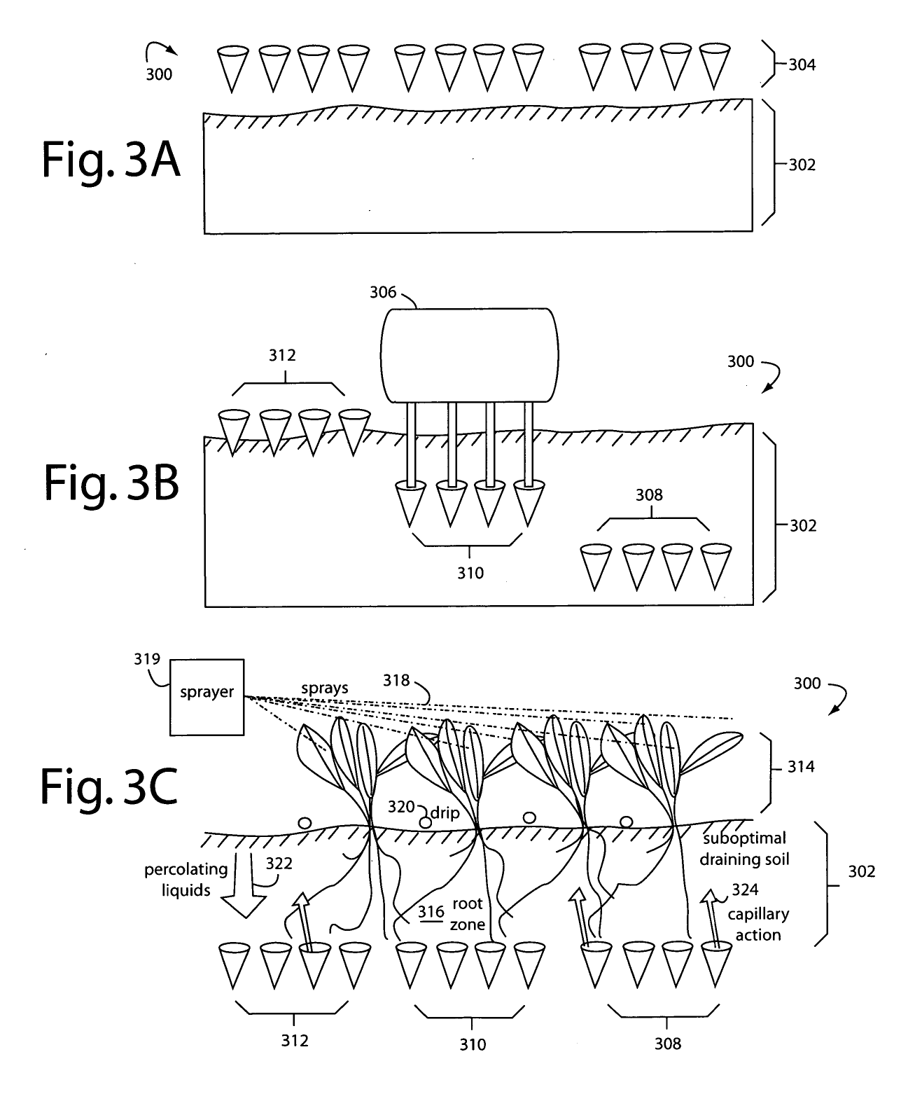

FIGS. 3A-3C represent another farming method embodiment of the present invention, and is referred to herein by the general reference numeral 300. The method 300 is used when laying open the soil 302 to install an underlayment of liquid reserve wells 304 is not practical. Here, the individual units are forced into the ground by a machine 306. FIG. 3B shows three groups of liquid reserve wells 308, 310, and 312 in various stages of insertion. A typical vegetable farm operation tills the soil 302 to a depth of 18″, so it would be best in this case if the tops of the liquid reserve wells 308, 310, and 312 were pushed in by machine 306 deeper than 20″.

Contrast method 100 in FIG. 3C with FIG. 1. The two are near identical in appearance, and are similar in operation. A crop of plants 314 growing in a root zone 316 receives periodic sprays 318. These can include sprays of water, pesticide, herbicide, and fertilizer. A drip irrigation 320 can also be used. These result in percolating liquids 322 that will partially be collected by the liquid reserve wells 308, 310, and 312. A capillary action 324 will return some of the liquids to the root zone 316 between sprays or irrigation cycles.

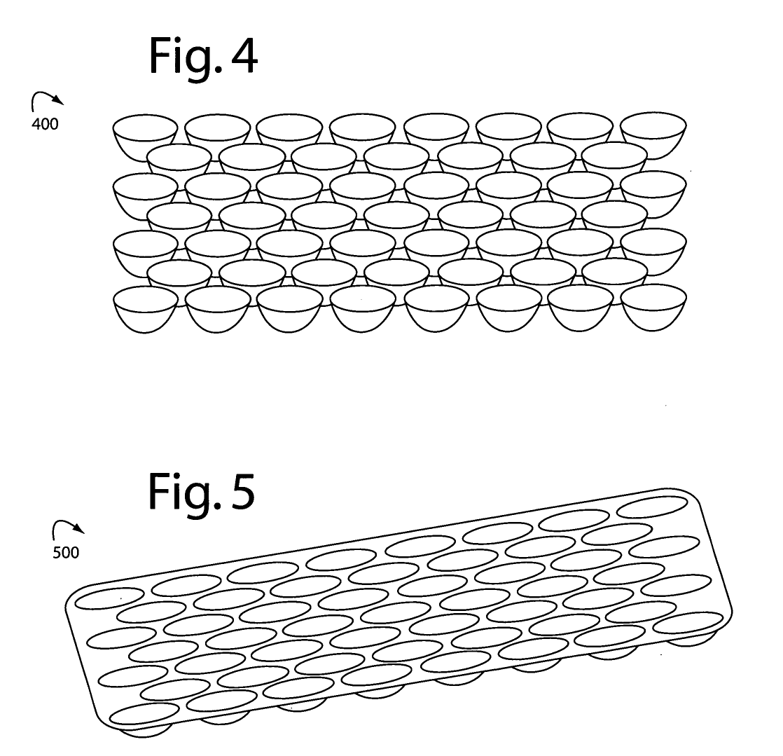

FIG. 4 represents a set of tapered reservoir cups 400 that can be used the same way that that the planar network of liquid reserve matrices 110-112 are used in farming system 100 (FIG. 1). Such have their openings pointed up so that they can fill with liquids underground. The specific sizes of each cup and the depth of their burial are empirically determined and dependent on the species of crops planted, the soil, and weather conditions. The individual cups here are individually formed and then connected together at their adjoining rims.

FIG. 5 represents a thermoformed sheet of tapered reservoir cups 500 that can be used the same way that that the planar network of liquid reserve matrices 110-112 are used in farming system 100 (FIG. 1). Such also have their openings pointed up so that they can fill with liquids underground. As in FIG. 4, the specific sizes of each cup and the depth of their burial are empirically determined and dependent on the species of crops planted, the soil, and weather conditions. The individual cups here are thermoformed in one sheet and are connected together at their rim tops.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A method of cultivating a commercial crop, comprising:
installing a planar network of liquid reserve matrices in a topsoil below a seasonal tilling depth and proximate to a root zone;
cultivating a commercial crop in said topsoil
irrigating a crop with a first amount of water applied at a first frequency; and
reducing the volume and/or frequency of watering, fertilizing, and application of herbicides and pesticides in proportion to the amount of liquids retained and topsoil drainage inhibited by said liquid reserve matrices;
wherein the amplitudes of wet-dry cycling stresses around a seasonal optimum are significantly reduced.

2. The method of claim 1, wherein:
the installing is such that said liquid reserve matrices are fabricated from water-proofed egg flats.

3. The method of claim 1, wherein:
the installing is such that said liquid reserve matrices are fabricated biodegradable materials.

4. The method of claim 1, wherein:
the installing is such that said liquid reserve matrices are cone-shaped cups that are forcibly driven-in point-first in a planar matrix into said topsoil;
wherein said topsoil need not be laid open to accept the liquid reserve matrices.

5. The method of claim 1, wherein:
the installing is such that said liquid reserve matrices are individual tapered reservoir cups that are joined together at their rims.

6. The method of claim 1, wherein:
the installing is such that said liquid reserve matrices are individual tapered reservoir cups that are thermoformed in one sheet together and joined.

7. A farming business model, comprising:
increasing crop yields and lowing production costs by reducing the stress on individual plants caused by seasonal wet-dry cycling amplitude extremes around an optimum, wherein a network of small reservoir cups is placed beneath the root zone and below the depth of seasonal tilling to limit drainage.
